(19) United States
(12) Patent Application Publication
(10) Pub. No.: US 2026/0082301 A1
(43) Pub. Date: Mar. 19, 2026

(54) CONDITIONAL HANDOVER CONFIGURATION STORAGE

(71) Applicant: Telefonaktiebolaget LM Ericsson (publ), Stockholm (SE)

(72) Inventors: Pradeepa RAMACHANDRA, Linköping (SE); Sakib BIN REDHWAN, Linköping (SE); Ali PARICHEHREHTEROUJENI, Linköping (SE); Marco BELLESCHI, Solna (SE)

(73) Assignee: Telefonaktiebolaget LM Ericsson (publ), Stockholm (SE)

(21) Appl. No.: 19/102,403

(22) PCT Filed: Aug. 7, 2023
(86) PCT No.: PCT/SE2023/050787

§ 371 Date: Feb. 9, 2025

Related U.S. Application Data
(60) Provisional application No. 63/396,473, filed on Aug. 9, 2022.

(51) Int. Cl. H04W 36/36; H04W 36/00; H04W 36/24

(52) U.S. Cl. CPC H04W 36/362; H04W 36/0079; H04W 36/249

(57) ABSTRACT

A communication device in a communications network receives a conditional handover configuration (“CHO”) from a first network node. The CHO can include an indication of a second network node. The communication devices stores the CHO. Subsequent to storing the CHO, the communication device determines a radio link failure (“RLF”) associated with the first network node or a handover failure (“HOF”) associated with a handover procedure towards the second network node. Subsequent to determining the RLF or the HOF, the communication device selects a third network node while a timer is running. The communication device transmits an indication to the third network node indicating that the communication device selected a cell hosted by the third network node as part of a cell selection procedure while the timer was running.

### TECHNICAL FIELD

The present disclosure is related to wireless communication systems and more particularly to avoiding unnecessary conditional handover configuration (“CHO”) storage at a network node.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Handovers can be triggered when the UE is at a cell edge and experiences poor radio conditions. If the UE enters poor radio conditions quickly the conditions may already be so poor that the actual handover procedure may be hard to execute. If the uplink (“UL”) is already bad it may lead to the network not being able to detect the measurement report transmitted by the UE and hence may not be able to initiate the handover procedure. Downlink (“DL”) problems may lead to the handover command (e.g., the RRCReconfiguration message with a reconfiguration WithSync field) not being able to successfully reach the UE. In poor radio conditions, the DL message is more often segmented, which increases the risk of retransmissions with an increased risk that the message doesn't reach the UE in time. Failed transmission of handover command is a common reason for unsuccessful handovers.

To improve mobility robustness and address the issues above, a concept known as conditional handover (“CHO”) is being introduced in the 3^{rd} generation partnership project (“3GPP”) Release 16. The key idea in CHO is that transmission and execution of the handover command are separated. This allows the handover command to be sent to the UE earlier (e.g., when the radio conditions are still good), thus increasing the likelihood that the message is successfully transferred. The execution of the handover command is done at a later point in time based on an associated execution condition. The execution condition can be in the form of a threshold (e.g., signal strength of candidate target cell becomes X dB better than the serving cell (sometimes referred to as an A3 event) or signal strength of serving cell becomes worse than X dBm and signal strength of candidate target cell becomes better than Y dBm (sometimes referred to as an A5 event)).

### SUMMARY

According to some embodiments, a method of operating a communication device in a communications network is provided. The method includes receiving a conditional handover configuration (“CHO”) from a first network node. The CHO includes an indication of a second network node. The method further includes storing the CHO. The method further includes, subsequent to storing the CHO, determining a radio link failure (“RLF”) associated with the first network node or a handover failure (“HOF”) associated with a handover procedure towards the second network node. The method further includes, subsequent to determining the RLF or the HOF, selecting a third network node while a timer is running. The method further includes transmitting an indication to the third network node indicating that the communication device selected a cell hosted by the third network node as part of a cell selection procedure while the timer was running.

According to other embodiments, a method of operating a network node in a communications network is provided. The method includes receiving an indication from a communication device indicating that the communication device selected a cell hosted by the network node as part of a cell selection procedure while a timer was running. The method further includes performing an action based on the indication.

According to other embodiments, a method of operating a first network node in a communications network is provided. The method includes transmitting a conditional handover configuration (“CHO”) to a communication device. The method further includes storing the CHO. The method further includes receiving an indication from a third network node indicating that the communication device selected a candidate target cell hosted by the third network node as part of a cell selection procedure while a timer was running. The method further includes performing an action based on the indication.

According to other embodiments, a communication device, network node, system, host, computer program, computer program product, or non-transitory computer-readable medium is provided to perform at least one of the above methods.

Certain embodiments may provide one or more of the following technical advantages. In some embodiments, the network node does not store the CHO configurations in certain scenarios when the UE would have already stored the CHO configurations as part of the RLF report. Such scenarios can occur when the UE performs CHO recovery procedure (applying RRC reconfiguration with sync toward a candidate cell when selected as part of re-establishment procedure). In such scenarios the CHO recovery cell does not know whether the CHO execution conditions were met or the CHO recovery was executed. Hence the node owning the CHO recovery cell stores the CHO configuration unnecessarily as the CHO configuration is already stored by the UE.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a signal flow diagram illustrating an example of a conditional handover;

FIG. 3 is a block diagram illustrating an example of self-configuration/self-optimization functionality;

FIG. 4 is a diagram illustrating an example of a RRCReconfigurationComplete message in accordance with some embodiments;

FIG. 5 is a table illustrating an example of RRCReconfigurationComplete-IEs filed descriptions in accordance with some embodiments;

FIG. 6 is a diagram illustrating an example of operations performed by a UE upon reception of the RRCReconfiguration in accordance with some embodiments;

FIG. 7 is a diagram illustrating an example of a UEInformationResponse message in accordance with some embodiments;

FIG. 8 is a table illustrating an example of RLF-Report field descriptions in accordance with some embodiments;

FIG. 9 is a diagram illustrating an example of operations performed by a UE upon receiving the UEInformationRequest message in accordance with some embodiments;

FIG. 10 is a signal flow diagram illustrating an example of UE assistance information in accordance with some embodiments;

FIG. 11 is a diagram illustrating an example of operations performed by a UE upon successful CHO recovery toward the serving cell in accordance with some embodiments;

FIG. 12 is a table illustrating an example of a HANDOVER SUCCESS message in accordance with some embodiments;

FIG. 13 is a table illustrating an example of a Message Type IE in accordance with some embodiments;

FIG. 14 is a flow chart illustrating example of operations performed by a communication device in accordance with some embodiments;

FIGS. 15-16 are flow charts illustrating examples of operations performed by a network node in accordance with some embodiments;

FIG. 17 is a block diagram of a communication system in accordance with some embodiments;

FIG. 18 is a block diagram of a user equipment in accordance with some embodiments;

FIG. 19 is a block diagram of a network node in accordance with some embodiments;

FIG. 20 is a block diagram of a host computer communicating with a user equipment in accordance with some embodiments;

FIG. 21 is a block diagram of a virtualization environment in accordance with some embodiments; and

FIG. 22 is a block diagram of a host computer communicating via a base station with a user equipment over a partially wireless connection in accordance with some embodiments in accordance with some embodiments.

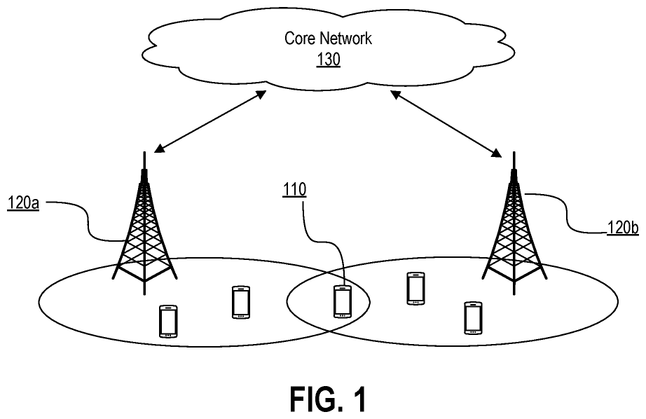

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Herein, a cell for which conditional handover (or another conditional mobility procedure) is configured is denoted a “candidate target cell” or a “potential target cell.” Similarly, a radio network node controlling a candidate/potential target cell is denoted “candidate target node” or “potential target node.” In a sense, once the CHO execution condition has been fulfilled for a candidate/potential target cell and CHO execution towards this candidate/potential target cell has been triggered, this cell is no longer “potential” or a “candidate” in the normal senses of the words, since it is no longer uncertain whether the CHO will be executed towards it. Hence, after the CHO execution condition has been fulfilled/triggered, the concerned candidate/potential target cell is herein sometimes referred to as “target cell.”

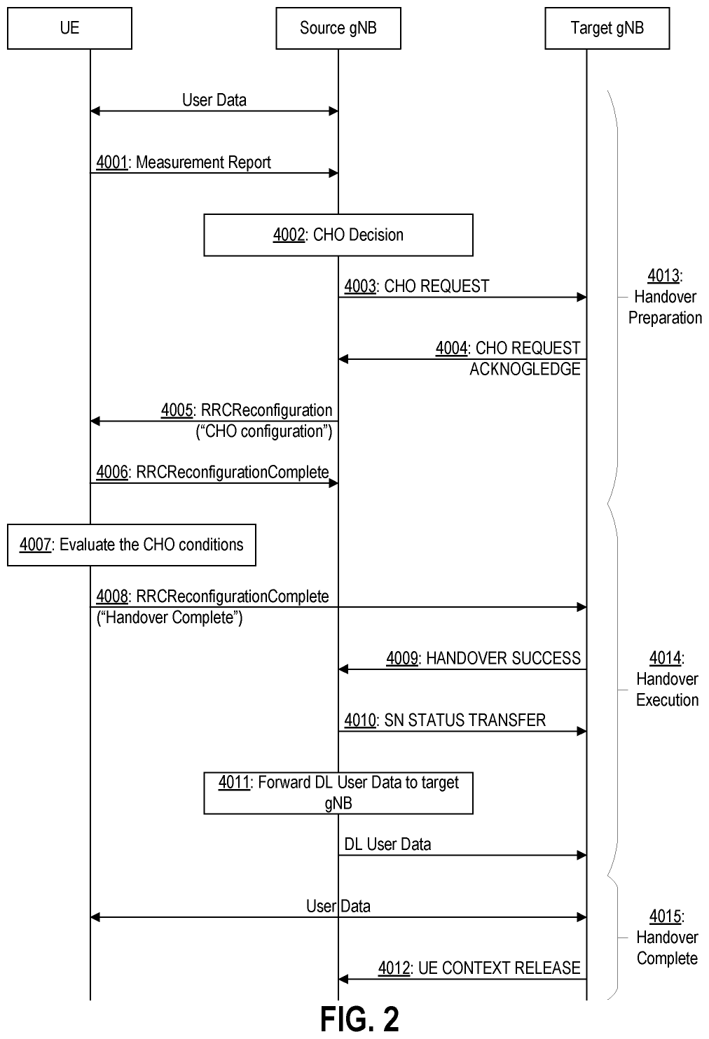

FIG. 2 illustrates an example of a signaling flow for a conditional handover.

At blocks 4001-4002, the UE and source gNB have an established connection and is exchanging user data. Due to some trigger (e.g., a measurement report from the UE), the source gNB decides to configure one or multiple CHO candidate cells. The threshold used for the measurement reporting should be chosen lower than the one in the handover execution condition. This allows the serving cell to prepare the handover when the radio link to the UE is still stable. The execution of the handover is done at a later point in time (and threshold) which is considered optimal for the handover execution.

At blocks 4003-4004, similar operations are performed as in a legacy handover procedure except that the source node indicates that the handover is a conditional handover.

At blocks 4005-4006, to configure a candidate target cell the source node sends the CHO configuration (e.g.,. a RRCReconfiguration message) to the UE which includes the handover command and the associated execution condition. The handover command (also an RRCReconfiguration message) is generated by the target node during the handover preparation phase and the execution condition is generated by the source node.

At blocks 4007-4008, if the execution condition is met, the UE executes the handover by performing random access and sending the handover complete message (i.e. an RRCReconfigurationComplete message) to the target node.

At block 4009, the target gNB sends a HANDOVER SUCCESS message to the source gNB indicating the UE has successfully established the target connection.

At blocks 4010-4011, upon reception of the handover success indication, the source gNB stops scheduling any further DL or UL data to the UE and sends a SN STATUS TRANSFER message to the target gNB indicating the latest PDCP SN transmitter and receiver status. The source node now also starts to forward User Data to the target node.

At block 4012, the same operations are performed as in the legacy handover procedure.

A Self-Organizing Network (“SON”) is an automation technology designed to make the planning, configuration, management, optimization and healing of mobile radio access networks simpler and faster. SON functionality and behavior has been defined and specified in generally accepted mobile industry recommendations produced by organizations such as 3GPP and the Next Generation Mobile Networks (“NGMN”).

In 3GPP, the processes within the SON area are classified into Self-configuration process and Self-optimization process. Self-configuration process is the process where newly deployed nodes are configured by automatic installation procedures to get the necessary basic configuration for system operation.

This process works in a pre-operational state. A pre-operational state can be understood as the state from when the eNB is powered up and has backbone connectivity until the radio frequency (“RF”) transmitter is switched on. This process works in an operational state. An operational state is understood as the state where the RF interface is additionally switched on.

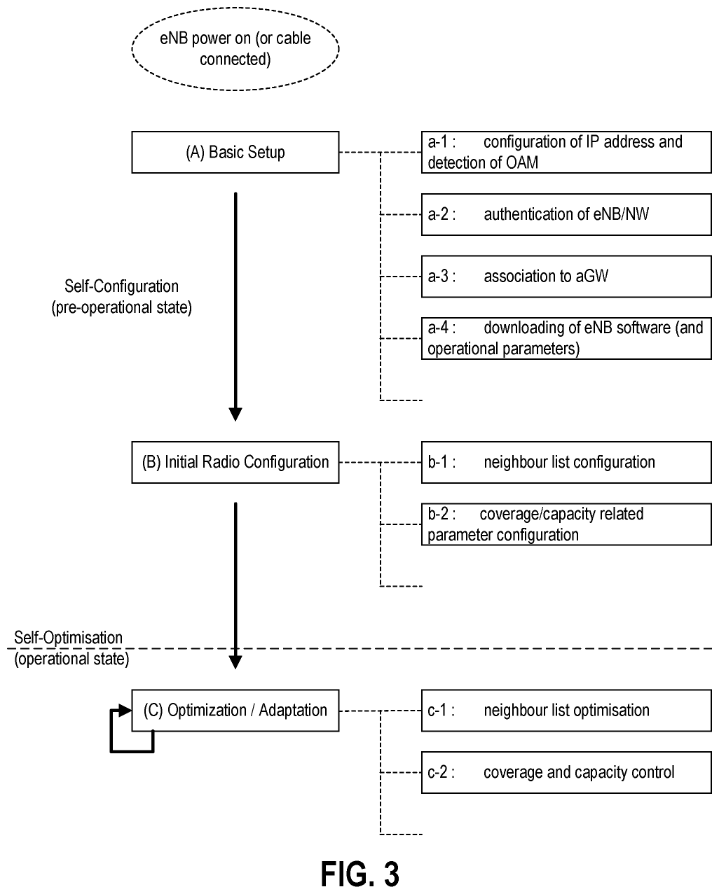

FIG. 3 illustrates an example of self-configuration and self-optimization functionality. Functions handled in the pre-operational state (e.g., basic setup and initial radio configuration) are covered by the Self Configuration process. The self-optimization process is defined as the process where UE and access node measurements and performance measurements are used to auto-tune the network. Functions handled in the operational state (e.g., optimization/adaptation) are covered by the self optimization process

In Long Term Evolution (“LTE”), support for Self-Configuration and Self-Optimisation is specified, as described in 3GPP TS 36.300 section 22.2, including features such as Dynamic configuration, Automatic Neighbour Relation (“ANR”), Mobility load balancing, Mobility Robustness Optimization (“MRO”), Random Access Channel (“RACH”) optimization and support for energy saving.

In new radio (“NR”), support for Self-Configuration and Self-Optimisation is specified as well, starting with Self-Configuration features such as Dynamic configuration, ANR in Rel-15, as described in 3GPP TS 38.300 section 15. In NR Rel-16, more SON features are being specified for, including Self-Optimisation features such as MRO.

MRO in 3GPP is described below.

Seamless handovers are a feature of 3GPP technologies. Successful handovers ensure that the UE moves around in the coverage area of different cells without causing too much interruption in the data transmission. However, there will be scenarios when the network fails to handover the UE to the ‘correct’ neighbor cell in time and in such scenarios the UE will declare a radio link failure (“RLF”) or Handover Failure (“HOF”).

Upon HOF and RLF, the UE may take autonomous actions (e.g., trying to select a cell and initiate reestablishment procedure so that we make sure the UE is trying to get back as soon as it can), so that it can be reachable again. The RLF can cause a poor user experience as the RLF is declared by the UE only when it realizes that there is no reliable communication channel (radio link) available between itself and the network. Also, reestablishing the connection requires signaling with the newly selected cell (random access procedure, radio resource control (“RRC”) Reestablishment Request, RRC Reestablishment, RRC Reestablishment Complete, RRC Reconfiguration, and RRC Reconfiguration Complete) and adds some latency, until the UE can exchange data with the network again.

Possible causes for a radio link failure can include: (1) Expiration of the radio link monitoring related timer T310; (2) Expiration of the measurement reporting associated timer T312 (not receiving the handover command from the network within this timer's duration despite sending the measurement report when T310 was running); (3) Upon reaching the maximum number of RLC retransmissions; and (4) Upon receiving random access problem indication from the MAC entity.

As RLF leads to reestablishment, which degrades performance and user experience, it is in the interest of the network to understand the reasons for RLF and to try to optimize mobility related parameters (e.g., trigger conditions of measurement reports) to avoid later RLFs. Before the standardization of MRO related report handling in the network, only the UE was aware of some information associated to how the radio quality looked like at the time of RLF, and what is the actual reason for declaring RLF. For the network to identify the reason for the RLF, the network needs more information, both from the UE and also from the neighboring base stations.

As part of the MRO procedure in LTE, RLF reporting procedure was introduced and standardized that the UE would log relevant information at the moment of an RLF and later report to a target cell the UE succeeds to connect (e.g., after reestablishment). That has also impacted the inter-gNodeB interface (e.g., X2AP specifications) as an eNodeB receiving an RLF report could forward to the eNodeB where the failure has been originated.

For the RLF report generated by the UE, its contents have been enhanced with more details. The measurements included in the measurement report can include: (1) Measurement quantities (reference signal received power (“RSRP”), reference signal received quality (“RSRQ”)) of the last serving cell (the primary cell (“PCell”)); (2) Measurement quantities of the neighbor cells in different frequencies of different radio access technologies (“RATs”) (e.g., universal terrestrial radio access (“UTRA”), evolved UTRA (“EUTRA”), global system for mobile communication (“GSM”) enhanced data rates for GSM Evolution (“GERAN”), and code division multiple access 2000 (“CDMA2000”)); (3) Measurement quantity (e.g., received signal strength indicator (“RSSI”)) associated to wide-local area network (“WLAN”) Aps; (4) Measurement quantity (RSSI) associated to BLUETOOTH beacons; (5) Location information, if available (including location coordinates and velocity); (6) Globally unique identity of the last serving cell, if available, otherwise the physical cell identifier (“PCI”) and the carrier frequency of the last serving cell; (7) Tracking area code of the PCell; (8) Time elapsed since the last reception of the ‘Handover command’ message; (9) cell radio network temporary identifier (“C-RNTI”) used in the previous serving cell; and (10) Whether or not the UE was configured with a data radio bearer (“DRB”) having a quality of service indicator (“QCI”) value of 1.

After the RLF is declared, the RLF report is logged and include in the VarRLF-Report and, once the UE selects a cell and succeeds with a reestablishment, it includes an indication that it has an RLF report available in the RRC Reestablishment Complete message, to make the target cell aware of that availability. Then, upon receiving an UEInformationRequest message, the UE shall include the RLF report (stored in a UE variable VarRLF-Report, as described above) in an UEInformationResponse message and send to the network.

Based on the RLF report from the UE and the knowledge about which cell did the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as too-early, too-late or handover to wrong cell classes. These handover failure classes are explained in brief below.

In some examples, the handover failure occurred due to a ‘too-late handover.’ The original serving cell can classify a handover failure to be a ‘too late handover’ when the original serving cell fails to send the handover command to the UE associated to a handover towards a particular target cell and if the UE reestablishes itself in this target cell post RLF. An example corrective action from the original serving cell can be to initiate the handover procedure towards this target cell a bit earlier by decreasing the cell individual offset (“CIO”) towards the target cell that controls when the IE sends the event triggered measurement report that leads to taking the handover decision.

In some examples, the handover failure occurred due to a ‘too-early handover.” The original serving cell can classify a handover failure to be ‘too early handover’ when the original serving cell is successful in sending the handover command to the UE associated to a handover however the UE fails to perform the random access towards this target cell. An example corrective action from the original serving cell can be to initiate the handover procedure towards this target cell a bit later by increasing the CIO towards the target cell that controls when the IE sends the event triggered measurement report that leads to taking the handover decision.

In some examples, the handover failure occurred due to a ‘handover-to-wrong-cell.’ The original serving cell can classify a handover failure to be ‘handover-to-wrong-cell’ when the original serving cell intends to perform the handover for this UE towards a particular target cell but the UE declares the RLF and reestablishes itself in a third cell. An example of a corrective action from the original serving cell can be to initiate the measurement reporting procedure that leads to handover towards the target cell a bit later by decreasing the CIO towards the target cell or via initiating the handover towards the cell in which the UE reestablished a bit earlier by increasing the CIO towards the reestablishment cell.

There currently exist certain challenges, which can be explained using the following example: (1) A UE is in Cell-A; (2) Cell-A configures the UE with CHO towards Cell-B and Cell-C; (3) The UE either declares RLF in Cell-A or declares HOF while performing CHO towards Cell-B; (4) The UE performs cell selection and finds Cell-C and applies stored RRCReconfiguration towards Cell-C; (5) The UE sends a RRCReconfigurationComplete message to Cell-C; (6) The Cell-C sends a HO SUCCESS message to Cell-A; (7) Cell-A forwards the CHO configuration to Cell-C as part SN STATUS TRANSFER to aid the CHO configuration storage to aid HO parameter optimization if the handover from Cell-A to Cell-C is deemed too early; (8) UE declares RLF in Cell-C; and (9) At a much later point in time a network node, say Cell-D, fetches the RLF report from the UE.

Until the arrival of the RLF report, the Cell-C needs to store the CHO configuration although the UE never used the CHO triggering conditions to enter the Cell-C and thus, the storage of CHO configuration is done unnecessarily by Cell-C. Similarly, in the above described scenario, also the source cell A does not know that the cell C was not the cell in which the CHO triggering conditions were satisfied (e.g., it does not know that the candidate target cell that the UE selected was just selected to recover the RRC connection).

Certain aspects of the disclosure and their embodiments may provide solutions to these or other challenges. In some embodiments, while performing CHO recovery to a cell, the UE includes an indication in a message (e.g., RRCReconfigurationComplete message) to indicate that the UE selected this cell while T311 was running and then it applied the stored RRCReconfiguration from the VarConditionalReconfig. Upon receiving such an indication in the message, the network node performs one of the following operation. In some examples, if the target network node had previously received any CHO configuration from the source cell (e.g., as part of the HO preparation), then the network node shall remove these CHO configurations from its memory.

In additional or alternative examples, in the HO SUCCESS message sent to the source cell, the target network node indicates that the UE has arrived in the target network node via a CHO recovery procedure and thus there is no need to forward the CHO configurations to the network node by the source cell. Upon receiving such an information, the source cell could perform at least one of the following: 1) Delete the CHO configurations as configured to the UE (as the RLF report stored by the UE is supposed to be self-contained with all the CHO related configurations); 2) If the source cell does not receive the corresponding RLF report in the future (based on the C-RNTI included in the RLF report), the source cell increments the number of failures; and 3) Do not transmit the SN STATUS TRANSFER to the target cell containing the CHO configuration.

In some embodiments, the UE can perform operations to aid the network to tune the mobility parameter configurations. The operations can include receiving a conditional handover configurations from a first network node. The operations can further include storing the conditional handover configurations. The operations can further include performing one of the following actions: (1) Declaring radio link failure in the first network node; and (2) Declaring handover failure while performing a handover procedure (reconfiguration with sync procedure) towards a second network node, the second network node hosting a cell being a candidate in the conditional handover configurations. Performing the handover procedure can occur after the corresponding conditions associated to the conditional handover configuration was met. The operations can further include performing a cell selection procedure. The operations can further include selecting a third network node, while a timer (T311) is running, hosting a cell for which the UE has stored conditional handover configuration. Applying the stored conditional handover configuration associated to the said candidate target cell hosted by the third network node. The operations can further include sending an indication to the third network node indicating that the UE selected the said candidate target cell hosted by the third network node as part of the cell selection procedure while the timer (T311) was running.

In additional or alternative embodiments, a third network node can perform operations to aid the network to tune the mobility parameter configurations. The operations can include receiving an indication from the UE indicating that the UE selected the target cell hosted by the third network node as part of the cell selection procedure while a supervision timer (T311) was running. The operations can further include, based on the received indication, performing one or more of the following actions: (1) Sending an indication to the first network node indicating that the UE selected the candidate target cell hosted by the third network node as part of the cell selection procedure while a supervision timer (T311) was running (e.g., sending the indication as part of the HO SUCCESS message); (2) Deleting any stored conditional handover configuration as configured to the UE by the first network node for the selected candidate target cell. This method may imply removing from the UE context, if previously stored by the third network node, the conditional handover configuration information, or ignoring it; and (3) Ignoring the CHO configuration information, if transmitted in the SN STATUS TRANSFER message from the first network node to the third network node. This embodiment may imply that the third network node does not keep in the stored UE context the CHO configuration information.

In additional or alternative embodiments, a first network node performs operations to aid the network to tune the mobility parameter configurations. The operations can include sending a conditional handover configurations to a UE. The operations can further include storing the conditional handover configuration as configured to the UE. The operations can further include receiving an indication from the third network node indicating that the UE selected the candidate target cell hosted by the third network node as part of the cell selection procedure while a timer (T311) was running. The operations can further include, based on the received indication, performing one or more of the following actions: (1) deleting the stored conditional handover configuration, if previously stored by the first network node, as configured to the UE; and (2) if the indication is received in the HO SUCCESS message, transmitting the SN STATUS TRANSFER message to the third network node without indicating the CHO configuration information associated to the UE.

Although the embodiments herein may generally be described in regards to new radio (“NR”), the innovations are applicable to Long Term Evolution (“LTE”) as well as other suitable radio access technologies (“RATs”).

Although the embodiments herein may generally refer to a timer named T311.

This is just an example of a timer that is initiated at the beginning of the radio resource control (“RRC”)-reestablishment procedure and stopped upon finding a suitable cell. Any suitable timer having similar behavior may be used.

Embodiments from a UE perspective are described below.

In some embodiments, the UE indicates that the UE has entered the cell via cell selection procedure when T311 was running. In additional or alternative embodiments, this indication is included by the UE in the RRCReconfigurationComplete message transmitted to the CHO recovery cell (e.g., a third network node).

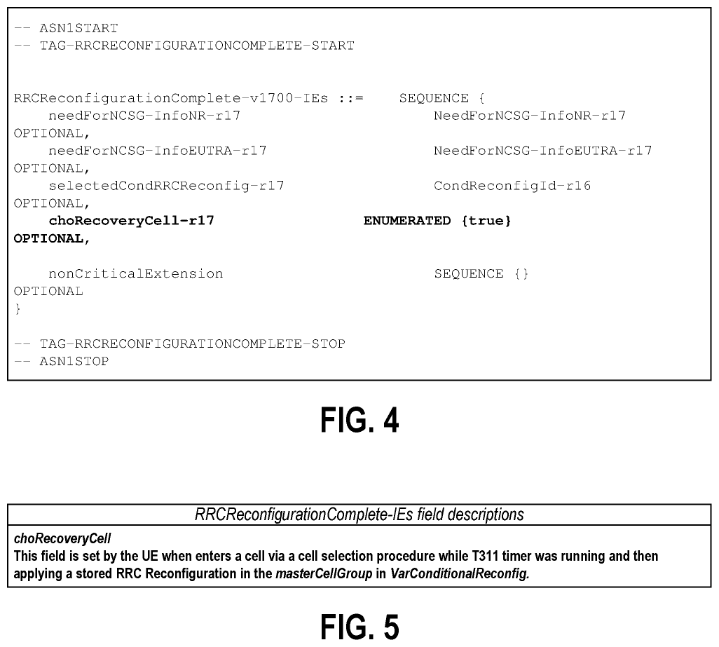

FIG. 4 illustrates an example of the RRCReconfigurationComplete message that can be used to confirm the successful completion of an RRC connection reconfiguration.

FIG. 5 illustrates an example of RRCReconfigurationComplete field descriptions.

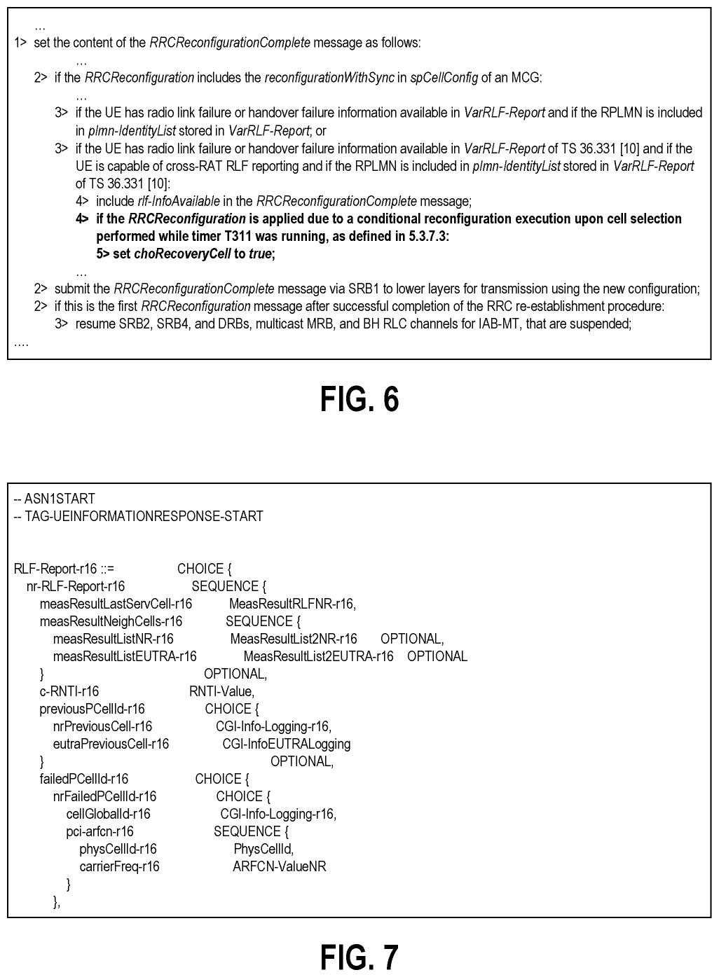

FIG. 6 illustrates an example of operations that can be performed by the UE in response to receiving the RRCReconfiguration message, or upon execution of the conditional reconfiguration (e.g., CHO, CPA, or CPC).

In additional or alternative embodiments, this indication is included by the UE in the UEInformationResponse message. The UEInformationResponse can include the RLF-Report, which can include all the information associated to the RLF the UE experienced in the selected CHO recovery cell hosted by the third network node. Since the UEInformationResponse is received by the third network node after the CHO recovery, at the moment of receiving the said UEInformationResponse, the third network node may have already sent the HO SUCCESS message to the first network node, and the first network node may have already sent the SN STATUS TRANSFER to the third network node containing the CHO configuration information associated to the UE. Thus, at the moment of receiving the UEInformationResponse, the third network node may have stored a UE context associated to the UE, including the concerned CHO configuration information. Hence, some operations can imply that if the indication is received by the third network node in the UEInformationResponse, the third network node deletes or ignores the CHO configuration information associated to this UE and previously stored in the UE context.

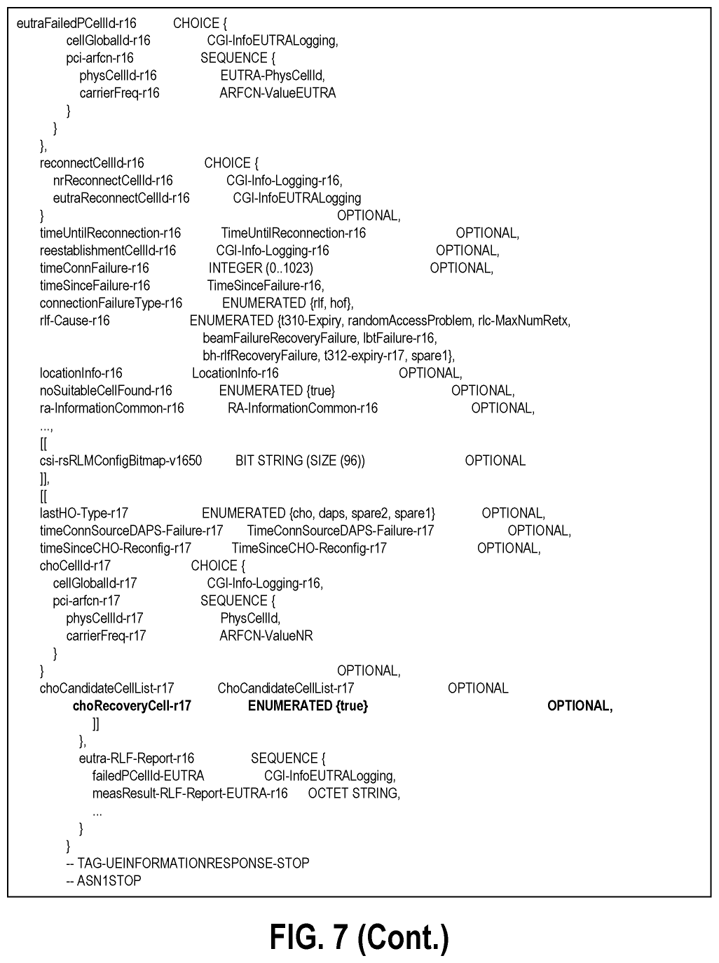

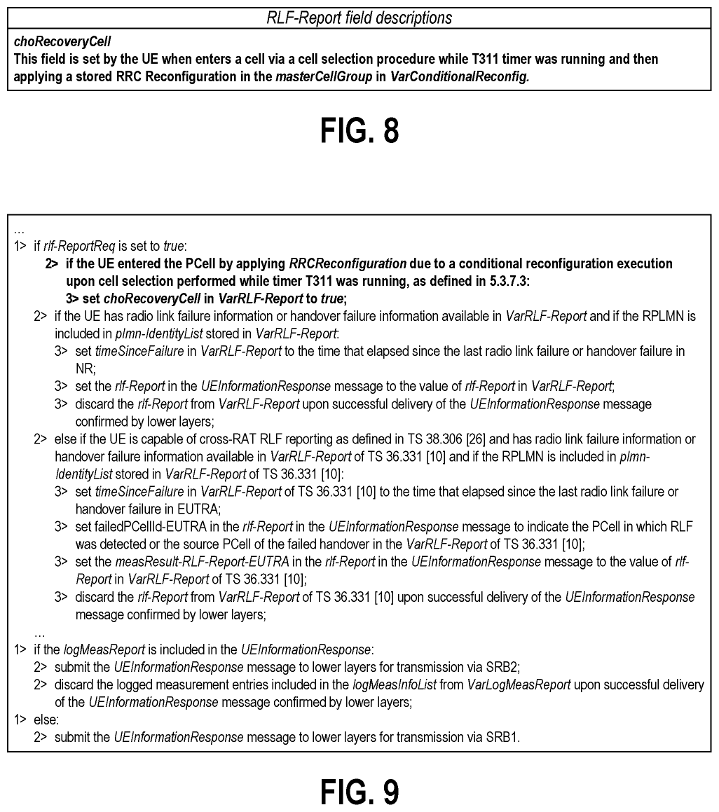

FIG. 7 illustrates an example of the UEInformationResponse message that is used by the UE to transfer information requested by the network. FIG. 8 illustrates an example of RLF-Report field descriptions.

FIG. 9 illustrates an example of operations that can be performed by the UE in response to receiving the UEInformationRequest message (only after successful security activation).

In additional or alternative embodiments, the UE may use a UEAssiatnceInformation signal to send the indication that it applied the CHO recovery procedure when it selected the current cell and the supervision timer T311 was running.

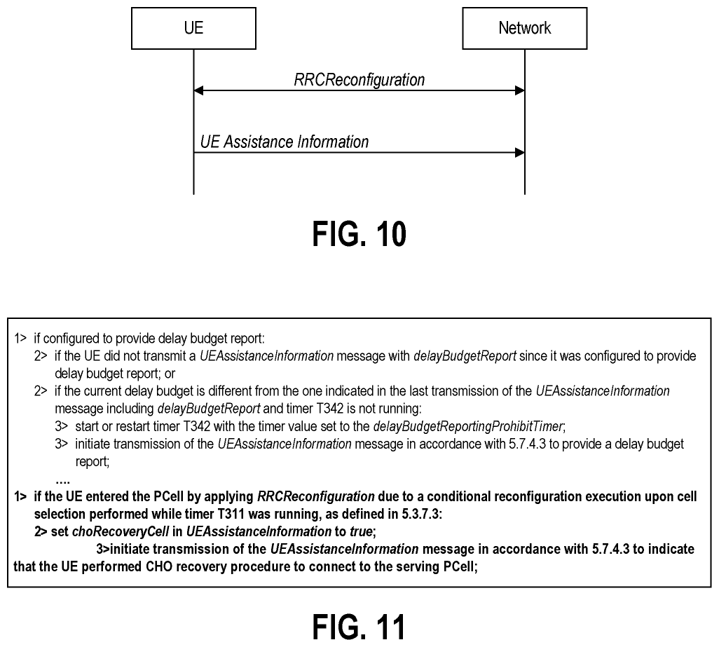

An example implementation of using the UEAssistanceInformation signal is illustrated in FIG. 10. The purpose of this procedure is for the UE to inform the network of:
its delay budget report carrying desired increment/decrement in the connected mode DRX cycle length;
its overheating assistance information;
its IDC assistance information;
its preference on DRX parameters for power saving;
its preference on the maximum aggregated bandwidth for power saving;
its preference on the maximum number of secondary component carriers for power saving;
its preference on the maximum number of MIMO layers for power saving;
its preference on the minimum scheduling offset for cross-slot scheduling for power saving;
its preference on the RRC state;
configured grant assistance information for NR sidelink communication;
its preference in being provisioned with reference time information;
its preference for FR2 UL gap;
its preference to transition out of RRC_CONNECTED state for MUSIM operation;
its preference on the MUSIM gaps;
its relaxation state for RLM measurements;
its relaxation state for BFD measurements;
availability of data and/or signaling mapped to radio bearers which are not configured for SDT;
its preference for the SCG to be deactivated;
indicate that the UE has uplink data to transmit for a DRB for which there is no MCG RLC bearer while the SCG is deactivated;
change of its fulfilment status for RRM measurement relaxation criterion;
service link propagation delay difference between serving cell and neighbor cell(s); or
CHO recovery procedure.

In some embodiments, a UE capable of providing a delay budget report in RRC_CONNECTED may initiate the procedure in several cases, including upon being configured to provide delay budget report and upon change of delay budget preference.

In additional or alternative embodiments, a UE capable of providing overheating assistance information in RRC_CONNECTED may initiate the procedure if it was configured to do so, upon detecting internal overheating, or upon detecting that it is no longer experiencing an overheating condition.

In additional or alternative embodiments, a UE capable of providing IDC assistance information in RRC_CONNECTED may initiate the procedure if it was configured to do so, upon detecting IDC problem if the UE did not transmit an IDC assistance information since it was configured to provide IDC indications, or upon change of IDC problem information.

In additional or alternative embodiments, a UE capable of providing service link propagation delay difference between serving cell and neighbour cell(s) shall initiate the procedure upon being configured to do so, and upon determining that service link propagation delay difference between serving cell and a neighbour cell has changed more than threshPropDelayDiff compared with the last reported value.

In additional or alternative embodiments, a UE capable of CHO recovery shall initiate the procedure upon successful CHO recovery toward the serving cell. FIG. 11 illustrates an example of operations performed by the UE upon initiating the procedure.

Embodiments from a network node perspective are described below.

There are two aspects to network node related embodiments as different network nodes could be involved in the associated procedure. These aspects are based on at what stage of connecting to the CHO recovery cell (e.g., the third network node) the UE indicates to the CHO recovery cell that it has performed CHO recovery.

If the UE sends the information as described above, as part of the RRCReconfigurationComplete message, to the CHO recovery cell (e.g., third network node) before the transmission of HO SUCCESS message to the source cell (e.g., first network node) that configured the CHO configuration to the UE, then the CHO recovery cell (e.g., third network node) could send an indication to the source cell (e.g., first network node) that configured the CHO configuration to the UE. This indication indicates to the source cell (e.g., first network node) that there is no need to forward the CHO configurations to the CHO recovery cell (e.g., third network node) as the UE has declared either a radio link failure or a handover failure before entering the CHO recovery cell. Such an indication could be sent over a message like HANDOVER SUCCESS message in X2/Xn specification.

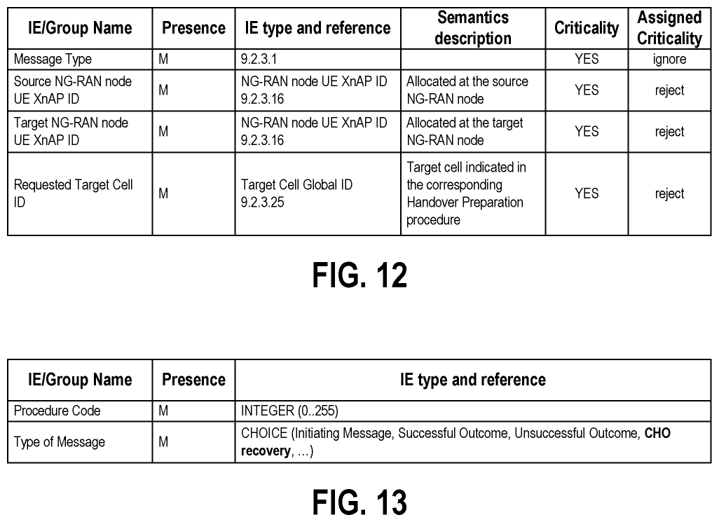

FIG. 12 illustrates an example of a HANDOVER SUCCESS message. This message is sent by the target NG-RAN node to the source NG-RAN node to indicate the successful access of the UE toward the target NG-RAN node.

FIG. 13 illustrates an example of a Message Type IE that uniquely identifies the message being sent. It can be mandatory for all messages.

Based on the reception of such an indication from the CHO recovery cell (e.g., third network node), the source cell (e.g., first network node) refrains from sending the CHO configuration to the CHO recovery cell (e.g., third network node) in the SN STATUS TRANSFER message. Alternatively, in another embodiment, the CHO recovery cell (e.g., third network node) may not send any indication to the source cell (e.g., first network node), upon receiving the indication from the UE. Hence, in this case, the source cell (e.g., first network node) may transmit to the CHO recovery cell (e.g., third network node) the SN STATUS TRANSFER message containing the CHO configuration information. If this happens, the CHO recovery cell (e.g., third network node) may ignore the said received CHO configuration information, and refrain from storing them in the corresponding UE context.

If the UE sends the information as part of, for example, the UEInformationResponse, to the CHO recovery cell (e.g., third network node) after the transmission of HO SUCCESS message to the source cell that configured the CHO configuration to the UE, then the CHO recovery cell (e.g., third network node) could just remove from its memory or ignore any received CHO configurations from the source cell in the SN STATUS TRANSFER message associated to the UE, and previously stored in the corresponding UE context.

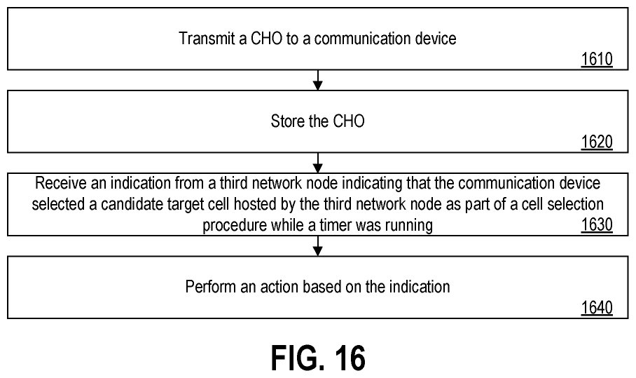

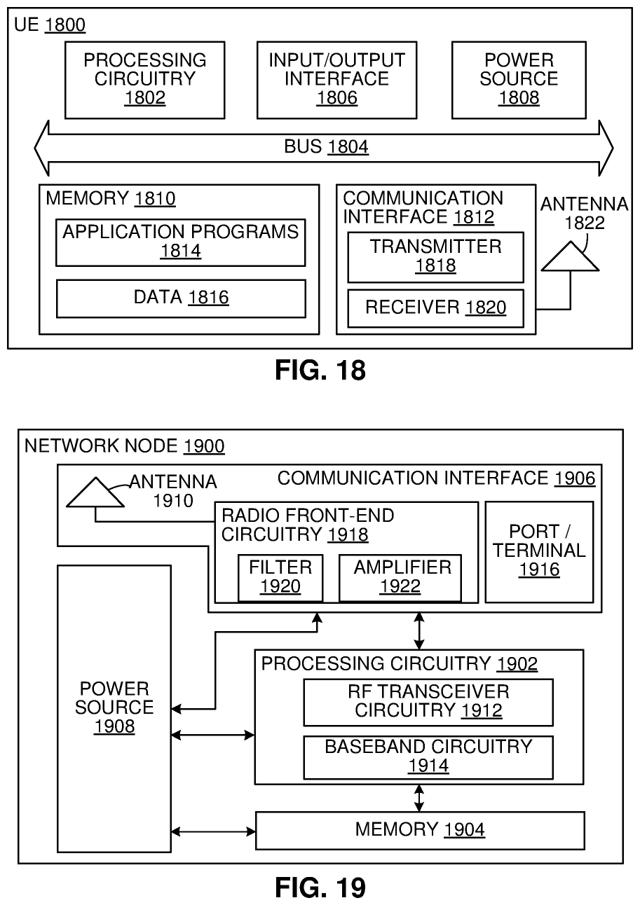

In the description that follows, while the communication device may be any of wireless device 1712A-B, wireless devices UE 1712C-D, UE 1800, virtualization hardware 2104, virtual machines 2108A, 2108B, or UE 2206, the UE 1800 (also referred to herein as communication device 1800) shall be used to describe the functionality of the operations of the communication device. Operations of the communication device 1800 (implemented using the structure of the block diagram of FIG. 18) will now be discussed with reference to the flow chart of FIG. 16 according to some embodiments of inventive concepts. For example, modules may be stored in memory 1810 of FIG. 18, and these modules may provide instructions so that when the instructions of a module are executed by respective communication device processing circuitry 1802, processing circuitry 1802 performs respective operations of the flow chart.

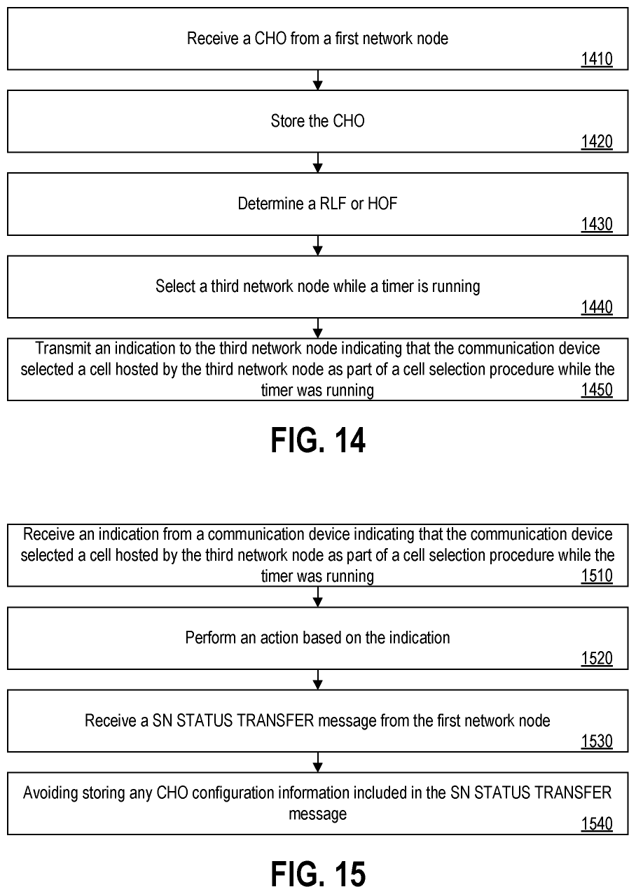

FIG. 14 illustrates an example of operations performed by a communication device in a communications network.

At block 1410, processing circuitry 1802 receives, via communication interface 1812, a CHO from a first network node.

At block 1420, processing circuitry 1802 stores the CHO.

At block 1430, processing circuitry 1802 determines a RLF or a HOF.

At block 1440, processing circuitry 1802 selects a third network node while a timer is running. In some embodiments, the timer is a timer initiated at the beginning of a radio resource control, RRC, reestablishment procedure and stopped upon finding a suitable cell. In some examples, the timer is a T311 timer.

At block 1450, processing circuitry 1802 transmits, via communication interface 1812, an indication to the third network node indicating that the communication device selected a cell hosted by the third network node as part of a cell selection procedure while the timer was running.

Various operations illustrated in FIG. 14 may be optional in respect to some embodiments.

In the description that follows, while the network node may be any of network nodes 1710A-B, core network node 1708, HUB 1714, network node 1900, virtualization hardware 2104, virtual machines 2108A, 2108B, or network node 2204, the network node 1900 shall be used to describe the functionality of the operations of the communication device. Operations of the network node 1900 (implemented using the structure of the block diagram of FIG. 19) will now be discussed with reference to the flow charts of FIGS. 15-16 according to some embodiments of inventive concepts. For example, modules may be stored in memory 1904 of FIG. 19, and these modules may provide instructions so that when the instructions of a module are executed by respective network node processing circuitry 1902, processing circuitry 1902 performs respective operations of the flow charts.

FIG. 15 illustrates an example of operations performed by a network node (e.g., the network node the UE connects to) in a communications network.

At block 1510, processing circuitry 1902 receives, via communication interface 1906, and indication from a communication device indicating that the communication device selected a cell hosted by the third network node as part of a cell selection procedure while the timer was running. In some embodiments, the timer is a timer initiated at the beginning of a radio resource control, RRC, reestablishment procedure and stopped upon finding a suitable cell. In some examples, the timer is a T311 timer.

At block 1520, processing circuitry 1902 performs an action based on the indication. In some embodiments, performing the action includes transmitting an indication to a first network node indicating that the communication device selected the cell hosted by the third network node as part of the cell selection procedure while the timer was running. In some examples, transmitting the indication includes transmitting a handover, HO, success message to the first network node.

In additional or alternative embodiments, performing the action includes deleting any stored conditional handover, CHO, configuration as configured to the communication device by the first network node for a cell associated with a second network node.

At block 1530, processing circuitry 1902 receives, via communication interface 1906, a SN STATUS TRANSFER message from the first network node.

At block 1540, processing circuitry 1902 avoids storing any CHO configuration information included in the SN STATUS TRANSFER message.

FIG. 16 illustrates an example of operations performed by a network node (e.g., the source network node) in a communications network.

At block 1610, processing circuitry 1902 transmits, via communication interface 1906, a CHO to a communication device.

At block 1620, processing circuitry 1902 stores the CHO.

At block 1630, processing circuitry 1902 receives, via communication interface 1906, an indication from a third network node indicating that the communication device selected a candidate target cell hosted by the third network node as part of a cell selection procedure while a timer is running. In some embodiments, the timer is a timer initiated at the beginning of a radio resource control, RRC, reestablishment procedure and stopped upon finding a suitable cell. In some examples, the timer is a T311 timer.

In additional or alternative embodiments, receiving the indication includes receiving a handover, HO, success message.

At block 1640, processing circuitry 1902 performs an action based on the indication. In some embodiments, performing the action includes deleting the CHO. In some examples, performing the action further includes transmitting a SN STATUS TRANSFER message to the third network node without indicating the CHO configuration information associated to the UE.

Various operations illustrated in FIGS. 15-16 may be optional in respect to some embodiments.

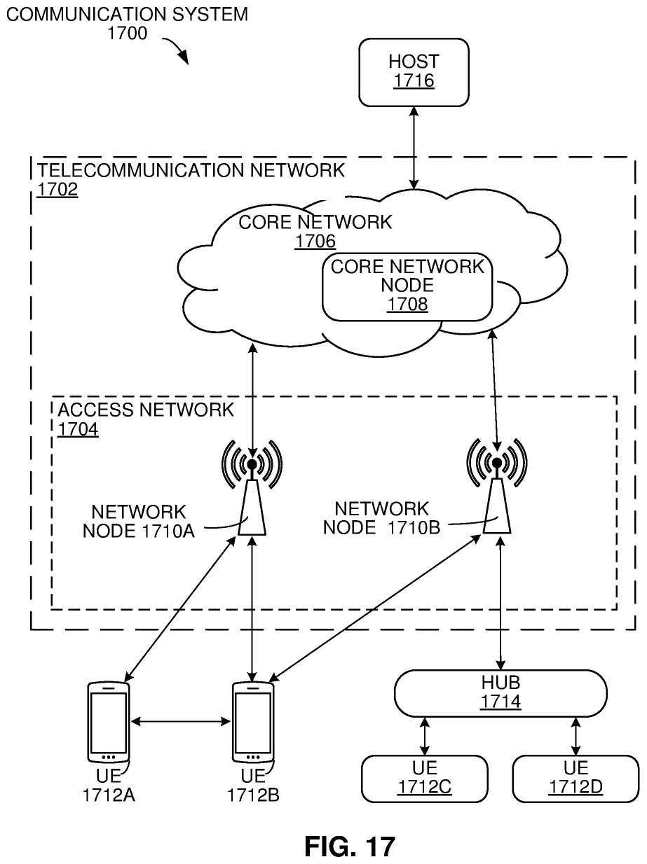

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3^{rd} Generation Partnership Project (3GPP) access node or non-3GPP access point. Moreover, as will be appreciated by those of skill in the art, the network nodes 1710 are not necessarily limited to an implementation in which a radio portion and a baseband portion are supplied and integrated by a single vendor. Thus, it will be understood that the network nodes 1710 may include disaggregated implementations or portions thereof. For example, in some embodiments, the telecommunication network 1702 includes one or more Open-RAN (ORAN) network nodes. An ORAN network node is a node in the telecommunication network 1702 that supports an ORAN specification (e.g., a specification published by the O-RAN Alliance, or any similar organization) and may operate alone or together with other nodes to implement one or more functionalities of any node in the telecommunication network 1702, including one or more network nodes 1710 and/or core network nodes 1708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1710 facilitate direct or indirect connection of user equipment (UE), such as by connecting wireless devices 1712a, 1712b, 1712c, and 1712d (one or more of which may be generally referred to as UEs 1712) to the core network 1706 over one or more wireless connections. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub-that is, a hub whose primary function is to route communications to/from the UEs from/to the network node 1710b. In other embodiments, the hub 1714 may be a non-dedicated hub-that is, a device which is capable of operating to route communications between the UEs and network node 1710b, but which is additionally capable of operating as a communication start and/or end point for certain data channels.

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

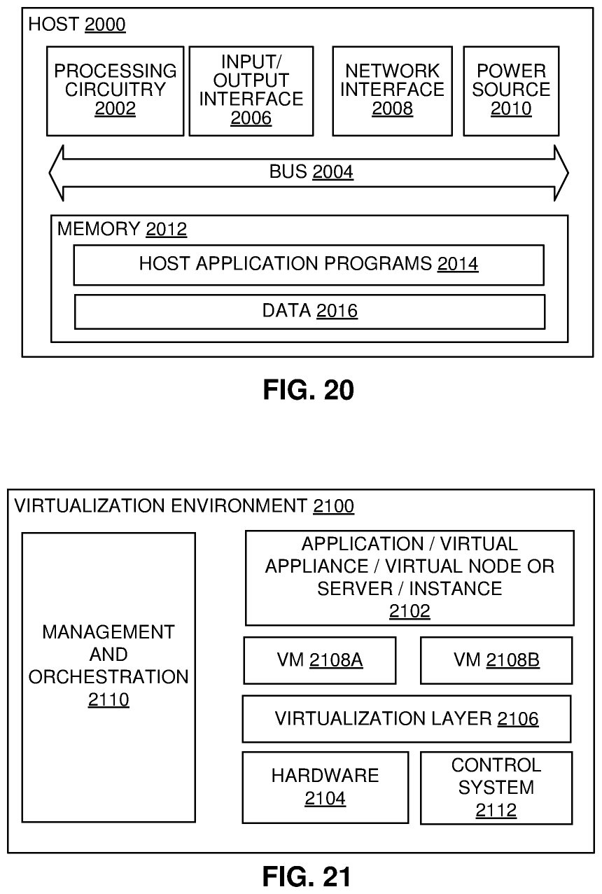

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2100 includes components defined by the O-RAN Alliance, such as an O-Cloud environment orchestrated by a Service Management and Orchestration Framework via an O-2 interface.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

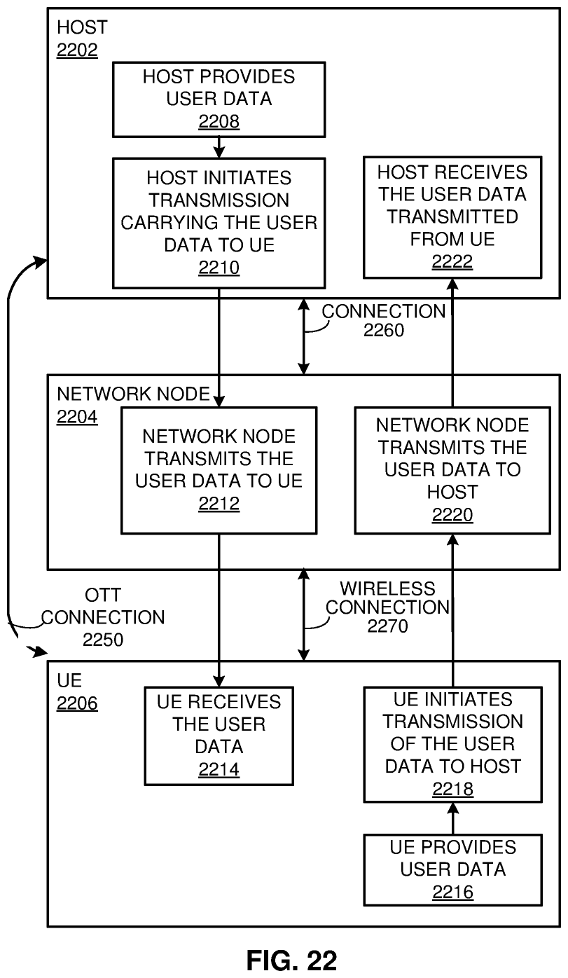

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment. More precisely, the teachings of these embodiments may allow a network node to not store the CHO configurations in certain scenarios when the UE would have already stored the CHO configurations as part of the RLF report. Such scenarios can occur when the UE performs CHO recovery procedure (applying RRC reconfiguration with sync toward a candidate cell when selected as part of re-establishment procedure). In such scenarios the CHO recovery cell does not know whether the CHO execution conditions were met or the CHO recovery was executed. Hence the node owning the CHO recovery cell stores the CHO configuration unnecessarily as the CHO configuration is already stored by the UE.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a communication device in a communications network, the method comprising:
receiving a conditional handover configuration, CHO, from a first network node, the CHO including an indication of a second network node;
storing the CHO;
subsequent to storing the CHO, determining a radio link failure, RLF, associated with the first network node or a handover failure, HOF, associated with a handover procedure towards the second network node;
subsequent to determining the RLF or the HOF, selecting a third network node while a timer is running;
transmitting an indication to the third network node indicating that the communication device selected a cell hosted by the third network node as part of a cell selection procedure while the timer was running.

2. The method of claim 1, wherein the timer is a timer initiated at the beginning of a radio resource control, RRC, reestablishment procedure and stopped upon finding a suitable cell.

3. The method of claim 1, wherein the timer is a T311 timer.

4. A method of operating a network node in a communications network, the method comprising:
receiving an indication from a communication device indicating that the communication device selected a cell hosted by the network node as part of a cell selection procedure while a timer was running; and
performing an action based on the indication.

5. The method of claim 4, wherein the timer is a timer initiated at the beginning of a radio resource control, RRC, reestablishment procedure and stopped upon finding a suitable cell.

6. The method of claim 4, wherein the timer is a T311 timer.

7. The method of claim 4, wherein the network node comprises a third network node,
wherein performing the action comprises transmitting an indication to a first network node indicating that the communication device selected the cell hosted by the third network node as part of the cell selection procedure while the timer was running.

8. (canceled)

9. The method of claim 4, wherein performing the action comprises deleting any stored conditional handover, CHO, configuration as configured to the communication device by the first network node for a cell associated with a second network node.

10. The method of claim 4, further comprising:
receiving a SN STATUS TRANSFER message from the first network node;
avoiding storing any conditional handover, CHO, configuration information included in the SN STATUS TRANSFER message.

11. A method of operating a first network node in a communications network, the method comprising:
transmitting a conditional handover configuration, CHO, to a communication device;
storing the CHO;
receiving an indication from a third network node indicating that the communication device selected a candidate target cell hosted by the third network node as part of a cell selection procedure while a timer was running; and
performing an action based on the indication.

12. The method of claim 11, wherein the timer is a timer initiated at the beginning of a radio resource control, RRC, reestablishment procedure and stopped upon finding a suitable cell.

13. The method of claim 11, wherein the timer is a T311 timer.

14. The method of claim 11, wherein performing the action comprises:
deleting the CHO.

15-16. (canceled)

17. A communication device operating in a communications network, the communication device comprising:
processing circuitry; and
memory coupled to the processing circuitry and having instructions stored therein that are executable by the processing circuitry to cause the communication device to perform operations comprising the operations of claim 1.

18-20. (canceled)

21. A network node operating in a communications network, the network node comprising:
processing circuitry; and
memory coupled to the processing circuitry and having instructions stored therein that are executable by the processing circuitry to cause the network node to perform operations comprising the operations of claim 4.

22-24. (canceled)
